(19) United States
(12) Patent Application Publication
(10) Pub. No.: US 2003/0137577 A1
(43) Pub. Date: Jul. 24, 2003

(54) Color image forming method and apparatus

(76) Inventor: Tadashi Shinohara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/320,399

(22) Filed: Dec. 17, 2002

(30) Foreign Application Priority Data
Dec. 18, 2001 (JP) 2001-384191

(51) Int. Cl. B41J 2/385

(52) U.S. Cl. 347/134; 347/140

(57) ABSTRACT

The present invention provides a color image forming method and a color image forming apparatus by which location deviations among toner images and the densities of the toner images can be detected with a simple detecting structure. In this color image forming apparatus, location detecting toner marks are formed at three or more locations in the main-scanning direction perpendicular to the conveying direction of a conveyor belt, and location deviations among the location detecting toner marks are detected from the outputs from sensors, so that location deviations among toner images formed by image forming units can be corrected. Also, the densities of density detecting toner patches formed on the conveyor belt are detected with at least one of the sensors for detecting the location detecting toner marks, so that the densities of toner images formed by the image forming units can be corrected. Thus, location deviations among toner images and the densities of the toner images can be detected with a simple structure.

### BACKGROUND OF THE INVENTION

1. Field of the Invention

The present invention relates to a color image forming method and a color image forming apparatus.

2. Description of the Related Art

As a conventional color image forming apparatus, there is a tandem-type image forming apparatus in which a plurality of electrophotographic image forming units are arranged along the conveying direction of a conveyor belt that conveys paper sheets. In the following, a color image forming apparatus of this type will be described.

The image forming units include a yellow (Y) image forming unit, a magenta (M) image forming unit, a cyan (C) image forming unit, and a black (BK) image forming unit. Each of the image forming units has a photosensitive drum. Around the photosensitive drum, each of the image forming units has a charger, an exposure unit, a developer, and a photosensitive member cleaner. The surface of each photosensitive member is uniformly charged by the charger, and the charged area is exposed to laser beams emitted from the exposure unit so as to form a latent image on the photosensitive drum. This latent image is then developed by the developer.

In an image forming operation, a paper sheet is conveyed to the first image forming unit (yellow) by the conveyor belt, and a toner image formed on the photosensitive drum is transferred onto the paper sheet. The paper sheet is further conveyed to the other image forming units one by one on the downstream side, and toner images of the other colors are transferred over the yellow toner image on the paper sheet. The excess toner remaining on the surfaces of the photosensitive drums is wiped off by a photosensitive member cleaner, so that the photosensitive drums can be ready for the next image forming operation. The paper sheet having the toner images of all the colors thereon is then separated from the conveyor belt and conveyed to a fixing unit that fixes the transferred toner images. After the fixing, the paper sheet is discharged from the apparatus.

With a color image forming apparatus having the above structure, there is a problem that color deviations are caused when the color toner images deviate from the respective transfer positions on a paper sheet to which they should have been transferred originally. With such location and color deviations, the quality of the color images is greatly degraded.

Examples of location deviations among color toner images include: resist deviations in the sub-scanning direction caused by a center distance error among the photosensitive drums of the image forming units; tilt deviations caused by uneven tilting of the photosensitive drums of the image forming units in the main-scanning direction or tilting of the optical system; resist deviations in the main-scanning direction caused by write position deviations of images; and magnification rate errors caused by variations of the scanning line lengths of the respective colors.

Various measures have already been taken to correct location deviations among toner images of different colors. To correct sub-scanning direction resist deviations and main-scanning direction resist deviations, a method of adjusting the scanning timing for writing a latent image with the exposure unit is employed. To correct tilt deviations, a method of adjusting the tilt of a component such as a reflecting mirror provided in the course of the optical path of each image forming unit is employed. As for magnification rate errors, a method of changing the write clock for writing a latent image or a method of displacing a reflecting mirror is employed.

To detect deviations among toner images, there has been a method that involves three or more sensors arranged in the main-scanning direction perpendicular to the conveying direction (or the rotating direction or the sub-scanning direction) of the conveyor belt in a color image forming apparatus. This method includes the steps of: forming location detecting toner marks, using each image forming unit, at such locations on the surface of the conveyor belt that all the sensors can read them; reading the location detecting toner marks with each of the sensors; detecting location deviations among toner images, based on the outputs of the sensors having read the location detecting toner marks; and correcting locations of images that are formed on the photosensitive drums by the image forming units, in accordance with the detected location deviations.

Since image quality is adversely affected not only by location deviations among toner images but also by density variations among the toner images, there has been a known method that includes the steps of: forming density detecting toner patches of all colors on the conveyor belt; reading the density detecting toner patches with a density sensor; detecting the densities of toner images from the Output of the density sensor having read the density detecting toner patches; and setting image forming conditions for the image forming units to form images in accordance with the detected image densities. Here, the image forming conditions include the charging bias in charging the photosensitive members, the laser beam power in forming a latent image by exposing the charged area, and the developing bias in developing the, latent image.

In the prior art, the density sensor for reading the density detecting toner patches is provided separately from the sensors for reading the location detecting toner marks. Therefore, a larger number of components and circuits are required, and the production costs are only increased. With a larger number of sensors, the degree of freedom in component arrangement is limited, and the sensors often need to be supported by a plurality of base members, only to further complicate the structure of the apparatus.

A latent image formed on a photosensitive member is visualized by applying toner thereto from a toner cartridge provided in the developer. However, since the toner stored in the toner cartridge is carried from one end to the other in the main-scanning direction, the density of a developed toner image is high at the one end in the main-scanning direction, but low at the other end in the main-scanning direction. Because of this, the density of the toner image becomes uneven in the main-scanning direction, even after the optical density of the latent image is made uniform in the main-scanning direction on the photosensitive member.

### SUMMARY OF THE INVENTION

A general object of the present invention is to provide a color image forming method and a color image forming apparatus in which the above disadvantages are eliminated.

A more specific object of the present invention is to provide a color image forming method and a color image forming apparatus by which location deviations among toner images and the densities of the toner images can be detected with a simple detecting structure.

Another specific object of the present invention is to provide a color image forming method and a color image forming apparatus by which optimum image forming conditions can be set based on the densities of toner images detected in the center region having the average toner application amount in the entire image forming area in the main-scanning direction.

Yet another specific object of the present invention is to provide a color image forming apparatus having a simple structure, with the number of base member for supporting sensors being very small.

The above objects of the present invention are achieved by a color image forming method that includes the steps of:

forming location detecting toner marks of different colors, using a plurality of electrophotographic image forming units, at three or more locations on a conveyor belt in a main-scanning direction that is perpendicular to the conveying direction of the conveyor belt;

forming density detecting toner patches of different colors, using the image forming units, at different locations on the conveyor belt that are the same as at least one of the location detecting toner marks in the main-scanning direction but different in the sub-scanning direction;

optically reading the location detecting toner marks with three or more sensors arranged in the main-scanning direction;

detecting location deviations among colors with respect to a reference color at each location of the sensors, based on the results of the detection of the location detecting toner marks obtained from the outputs of the sensors;

correcting the locations of images formed on photosensitive members by the image forming units, in accordance with the detected location deviations;

reading the density detecting toner patches with one or more of the sensors that are designed to read the location detecting toner marks; and

setting image forming conditions as to the image densities of images to be formed by the image forming units, based on the densities of the density detecting toner patches detected from the outputs of the sensors.

In accordance with this method, while the location detecting toner marks formed at several locations in the main-scanning direction are read by the respective sensors so as to correct the locations of toner images, the density detecting toner patches for setting image forming conditions as to image densities can be read by one or more of the sensors that also read the location detecting toner marks. Thus, the number of sensors employed in the apparatus can be reduced, and the production costs can be lowered.

The above objects of the present invention are also achieved by a color image forming apparatus that includes: a plurality of image forming units that are arranged in the conveying direction of a conveyor belt and form images of different colors by electrophotography; three or more sensors that are arranged in a main-scanning direction that is perpendicular to the conveying direction of the conveyor belt; a toner mark forming means that drives the image forming units to form location detecting toner marks of each color at such locations on the conveyor belt that all the sensors can read the respective location detecting toner marks from the conveyor belt; a toner patch forming means that drives the image forming units to form density detecting toner patches of each color at such locations on the conveyor belt that at least one of the sensors can read the density detecting toner patches from the conveyor belt; a location deviation detecting means that detects location deviations of colors with respect to a reference color at the location of each sensor, based on the outputs of the sensors that have read the location detecting toner marks; an image location correcting means that corrects the locations of images formed on photosensitive members by the image forming units, based on the detected location deviations; a density detecting means that uses one or more of the sensors, which read the location detecting toner marks, to detect the densities of the density detecting toner marks, based on the output of the one or more sensors that have read the density detecting toner patches; and an image forming condition setting means that sets image forming conditions as to the image densities of images to be formed by the image forming units, based on the detected densities.

In this color image forming apparatus, while the location detecting toner marks formed at several locations in the main-scanning direction are read by the respective sensors so as to correct the locations of toner images, the density detecting toner patches for setting image forming conditions as to image densities can be read by one or more of the sensors that also read the location detecting toner marks. Thus, the number of sensors employed in the apparatus can be reduced, and the production costs can be lowered.

The above objects of the present invention are also achieved by a color image forming apparatus that includes: a plurality of image forming units that form images of different colors by electrophotography; an intermediate transfer unit onto which images formed by the plurality of image forming units are transferred, the intermediate transfer unit being rotationally driven; a transfer means that transfers the images from the intermediate transfer unit to a paper sheet; three or more sensors that are arranged in a main-scanning direction perpendicular to the rotating direction of the intermediate transfer unit; a toner mark forming means that drives the image forming units to form location detecting toner marks of each color at such location on the intermediate transfer unit that all the sensors can read the respective location detecting toner marks; a toner patch forming means that drives the image forming units to form density detecting toner patches of each color at such locations on the intermediate transfer unit that at least one of the sensors can read the density detecting toner patches; a location deviation detecting means that detects location deviations of colors with respect to a reference color at the location of each sensor, based on the outputs of the sensors that have read the location detecting toner marks; an image location correcting means that corrects the locations of images formed on photosensitive members by the image forming units, in accordance with the detected location deviations; a density detecting means that uses at least one of the sensors, which read the location detecting toner marks, to detect the densities of the density detecting toner patches, based on the output of at least one of the sensors that have read the density detecting toner patches; and an image forming condition setting means that sets image forming conditions as to the image densities of images to be formed by the image forming units, in accordance with the detected densities.

In this color image forming apparatus, while the location detecting toner marks formed at several locations in the main-scanning direction are read by the respective sensors so as to correct the locations of toner images, the density detecting toner patches for setting image forming conditions as to image densities can be read by one or more of the sensors that also read the location detecting toner marks. Thus, the number of sensors employed in the apparatus can be reduced, and the production costs can be lowered.

In either of the above image forming apparatuses, the toner patch forming means forms the density detecting toner patches at such locations on the conveyor belt or the intermediate transfer unit that the sensor closest to the center of the main-scanning direction can read the density detecting toner patches.

With this structure, even if the toner supply amounts vary in the main-scanning direction in the developers, density detecting toner patches can be read in an area of the average toner application amount. Thus, the densities of toner images in the center area having the average toner attachment amount of the entire image forming region in the main-scanning direction can be detected, and optimum image forming conditions can be set.

Further in either of the above color image forming apparatuses, the toner patch forming means drives the image forming units to form density detecting toner patches of the same densities for each color at such locations on the conveyor belt or the intermediate transfer unit that each corresponding one of the sensors can read the density detecting toner patches. Also, the image forming condition setting means sets image forming conditions as to the image qualities of images to be formed by the image forming units, based on the average value of the outputs of the sensors corresponding to the detected densities of the density detecting toner patches.

With this structure, even if the toner supply amounts vary in the main-scanning direction in the developers, densities can be detected from the average value of the densities of the density detecting toner patches. Thus, optimum image forming conditions can be set for the entire image forming area in the main-scanning direction.

In any of the above color image forming apparatuses, the toner patch forming means forms density detecting toner patches of each color, and the image forming condition setting means sets image forming conditions for each color.

With this structure, the density of an image of each color can be set at a desired density.

In any of the above color image forming apparatuses, the toner patch forming means forms density detecting toner patches of different grayscale levels. Also, the image forming condition setting means sets image forming conditions as to the image qualities of images to be formed by the image forming units, based on the average value of the detected densities of the density detecting toner patches of the same grayscale levels.

With this structure, even if the toner supply amounts vary in the main-scanning direction in the developers, densities can be detected from the average value of the densities of the density detecting toner matches of the same grayscale levels. Accordingly, the image forming conditions can be further optimized.

In any of the above color image forming apparatuses, all the sensors are arranged on one base member.

Accordingly, the number of base members for supporting the sensors can be made very small, and the entire structure can be simplified.

### BRIEF DESCRIPTION OF THE DRAWINGS

The above and other objects, features, and advantages of the present invention will become more apparent from the following detailed description taken in conjunction with the accompanying drawings in which:

FIG. 1 is a front view of the inner structure of a color image forming apparatus in accordance with a first embodiment of the present invention;

FIG. 2 is a block diagram illustrating electric connections of the color image forming apparatus shown in FIG. 1;

FIG. 3 illustrates the relationship among location detecting toner marks, density detecting toner patches, and sensors, in the color image forming apparatus shown in FIG. 1;

FIG. 4 illustrates the relationship between density detecting toner patches and sensors in a color image forming apparatus in accordance with a second embodiment of the present invention;

FIG. 5 is a timing chart of signals for forming the density detecting toner patches and the location detecting toner marks in the color image forming apparatus shown in FIG. 4;

FIG. 6 is a flowchart of an image forming condition setting process in accordance with the second embodiment of the present invention; and

FIG. 7 is a front view of the inner structure of a color image forming apparatus in accordance with a third embodiment of the present invention.

### DESCRIPTION OF THE PREFERRED EMBODIMENTS

The following is a description of embodiments of the present invention, with reference to the accompanying drawings.

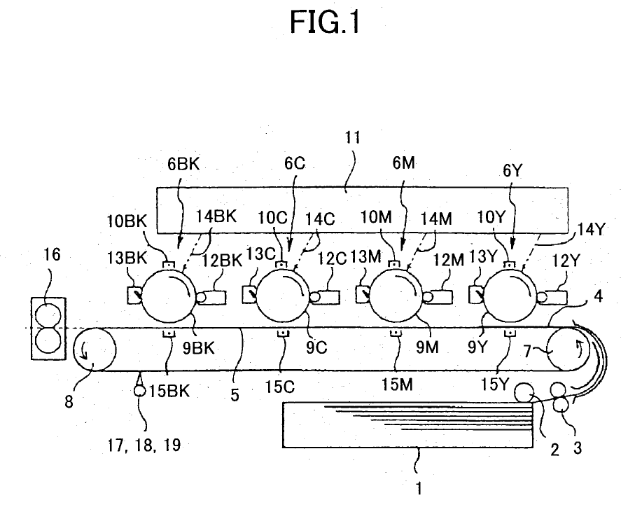

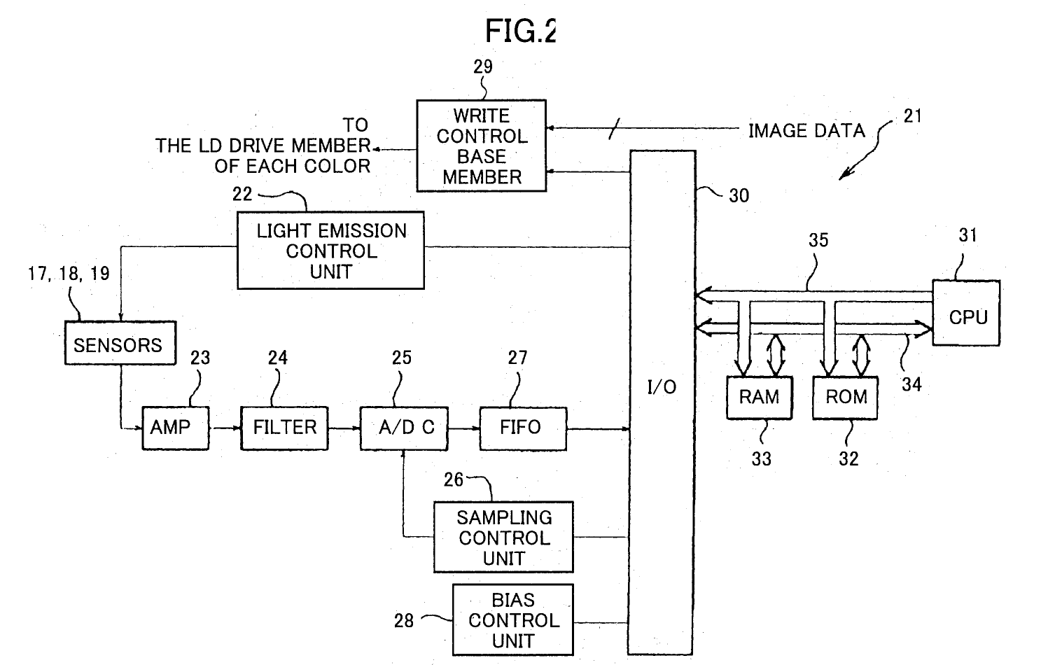

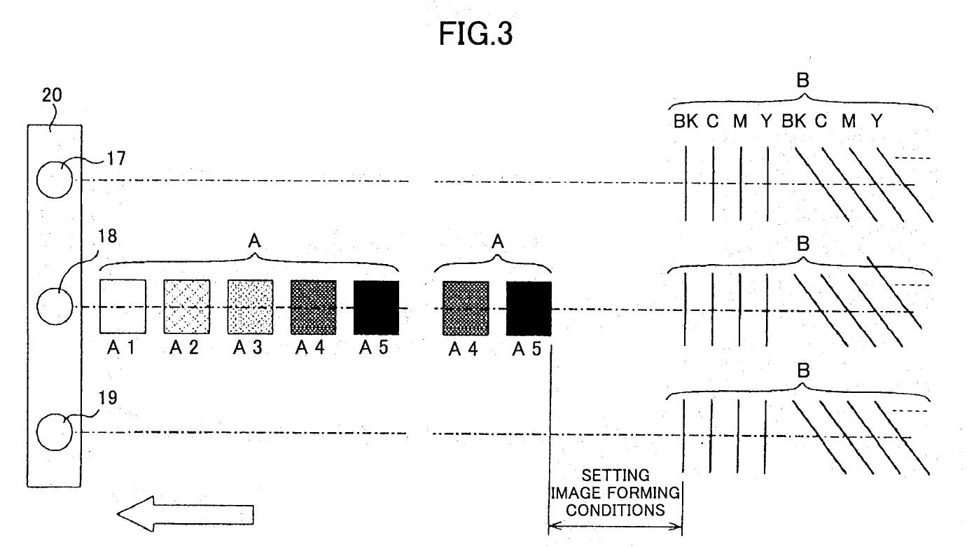

Referring first to FIGS. 1 through 3, a first embodiment of the present invention will be described FIG. 1 is a front view of the inner structure of a color image forming apparatus in accordance with this embodiment. FIG. 2 is a block diagram illustrating the structure of electric connections of the color image forming apparatus. FIG. 3 illustrates the relationship between location detecting toner marks and density detecting toner patches in the color image forming apparatus.

The color image forming apparatus of this embodiment is a so-called tandem type in which a plurality image forming units 6Y, 6M, 6C, and 6BK are arranged along a conveyor belt 5 in this order from the upstream side of the conveying direction of the conveyor belt 5. The conveyor belt 5 conveys paper sheets 4 that are fed from a paper feed tray 1 and are separated from one another by a paper feed roller 2 and a separating roller 3.

The image forming units 6Y, 6M, 6C, and 6BK have the same structures but form toner images of different colors. The image forming unit 6Y forms yellow images, the image forming unit 6M forms magenta images, the image forming unit 6C forms cyan images, and the image forming unit 6BK forms black images.

Although the image forming unit 6Y will be described in detail in the following description, explanation for the other image forming units 6M, 6C, and 6BK will be omitted, each having the same structure as the image forming unit 6Y. The components of each of the image forming units 6M, 6C, and 6BK are also shown in the drawings, with the reference numerals having M, C, or BK added thereto instead of Y added to the components of the image forming unit 6Y.

The conveyor belt 5 is an endless belt that is wound around a rotationally-driven driving roller 7 and a driven roller 8. The bigger arrow in FIG. 3 indicates the conveying direction of the conveyor belt 5.

In an image forming operation, the uppermost one of the paper sheets 4 stored in the paper feed tray 1 is sent out. The uppermost paper sheet 4 is attracted to the conveyor belt 5 by electrostatic attraction power, and is then conveyed to the first image forming unit 6Y by the rotationally-driven conveyor belt 5. At this point, a yellow toner image is transferred onto the paper sheet 4.

The image forming unit 6Y includes a photosensitive drum 9Y that serves as a photosensitive member. Around the photosensitive drum 9Y, the image forming unit 6Y has a charger 10Y, an exposure unit 11, a developer 12Y, a photosensitive member cleaner (not shown), and a dielectrifier 13Y. The exposure unit 11 is designed to emit exposure lights (laser beams in this embodiment) 14Y, 14M, 14C, and 14BK corresponding to the image colors formed by the image forming units 6Y, 6M, 6C, and 6BK.

In an image forming operation, the outer peripheral surface of the photosensitive drum 6Y is uniformly charged by the charger 10Y in the dark, and is then exposed by the yellow-image forming laser beam 14Y emitted from the exposure unit 11 to form a latent image. This latent image is visualized with a yellow toner by the developer 12Y. In this manner, a yellow toner image is formed on the photosensitive drum 9Y.

The yellow toner image is then transferred onto the paper sheet 4 by a transfer unit 15Y at a point where the paper sheet 4 on the conveyor belt 5 is brought into contact with the photosensitive drum 9Y, so that a yellow image is formed on the paper sheet 4. After the transfer of the toner image, the excess toner remaining on the outer peripheral surface of the photosensitive drum 9Y is wiped off by the photosensitive member cleaner. The photosensitive drum 9Y is then dielectrified by the dielectrifier 13Y, and awaits the next image forming operation.

The paper sheet 4 having the yellow toner image transferred thereto in the image forming unit 6Y is next conveyed to the image forming unit 6M by the conveyor belt 5. In the image forming unit 6M, a magenta toner image is formed on the photosensitive drum 9M in the same manner as the image forming manner in the image forming unit 6Y. The magenta toner image is then transferred onto the paper sheet 4. The paper sheet 4 is further conveyed to the image forming units 6C and 6BK, and a cyan toner image formed on the photosensitive drum 9C and a black toner image formed on the photosensitive drum 9BK are transferred onto the paper sheet 4. Thus, a full-color image is obtained. The paper sheet 4 now having the full-color image formed thereon is separated from the conveyor belt 5. After the color image on the paper sheet 4 is fixed by a fixing unit 16, the paper sheet 4 is discharged from the image forming apparatus.

With the color image forming apparatus having the above structure, there is a problem that the images of the different colors are not properly overlapped on one another, and location deviations are caused among the colors, due to center distance error and parallelism error among the photosensitive drums 9Y, 9M, 9C, and 9BK, arrangement error of a deflecting mirror (not shown) that deflects the laser beams within the exposure unit 11, and timing error in writing latent images onto the photosensitive drums 9Y, 9M, 9C, and 9BK.

It is therefore necessary to correct the location deviations in toner images. In the following, the structure designed for the correcting process will be described. As shown in FIG. 1, sensors 17, 18, and 19 that face the conveyor belt 5 are provided on the downstream side of the image forming unit 6BK. With the direction indicated by the bigger arrow in FIG. 3 being the conveying direction (the sub-scanning direction) of the conveyor belt 5, the sensors 17, 18, and 19 are supported by and arranged on a base member 20 in the main-scanning direction that is perpendicular to the direction indicated by the bigger arrow.

Referring now to FIG. 2, the structure of a signal processing unit 21 will be described. The sensors 17, 18, and 19 each has a light receiving device (not shown) controlled by a light emission control unit 22, and their output ends are connected to an I/O port 30 via an amplifier (AMP) 23, a filter 24, an analog-digital (A/D) converter 25, and a FIFO memory 27.

Each detection signal transmitted from the sensors 17, 18, and 19 is amplified by the amplifier 23, and passes through the filter 24. The detection signal is then converted from analog data to digital data by the analog-digital converter 25. The sampling of the data is controlled by a sampling control unit 26, and the sampled data is stored in the FIFO memory 27. The sampling control unit 26, the FIFO memory 27, a bias control unit 28, and a write control base member 29, are connected to the I/O port 30. The I/O port 30, a CPU 31, a ROM 32, and a RAM 33, are connected to one another by a data bus 34 and an address bus 35.

Various programs, such as a program for calculating location deviations of toner images and a program for performing an optimizing operation on the image forming conditions, are stored in the ROM 32. A ROM address, a RAM address, and other input/output devices, are designated through the address bus 35.

The CPU 31 monitors detection signals transmitted from the sensors 17, 18, and 19 in predetermined timing. The light emission control unit 22 controls the light emission amount of the light emitters of the sensors 17, 18, and 19, so that the detection of toner images can be surely performed even if there are deteriorations in the conveyor belt 5 and the light emitters of the sensors 17, 18, and 19. Thus, the output levels of light receiving signals transmitted from the light receiving devices can be uniform at all times.

The CPU 31 also determines settings in the write control base member 29 so that main and sub resists can be changed and each frequency can be changed with a magnification error, based on the correction amounts obtained from the detection results of location detecting toner marks B described later. In the write control base member 29, devices that can set very specific output frequencies, such as clock generators utilizing VCOs (Voltage Controller Oscillators), for example, are provided for the reference color and other colors. The outputs of these devices are used as image clocks.

The CPU 31 also sets the laser exposing power of the exposure unit 11 in the write control base member 29, based on image forming conditions obtained from the detection results of density detecting toner patches A described later. Further, the CPU 31 sets the developing bias of the developer 12 and the charging bias of the charger 10 in the bias control unit 28 via the I/O port 30.

In the following, the process of detecting and correcting the locations of images formed on the photosensitive drums 9Y, 9M, 9C, and 9BK, the process of detecting image densities, and the process of setting image forming conditions, will be described.

The CPU 31 drives the image forming units 6Y, 6M, 6C, and 6BK to form the density detecting toner patches A of each color (shown in FIG. 3) on the conveyor belt 5, and to form the location detection toner marks B of each color (shown in FIG. 3) on the conveyor belt 5. In short, the CPU 31 functions as a toner patch forming means and a toner mark forming means.

The density detecting toner patches A are four groups of patches of the colors BK, C, M, and Y. The density detecting toner patches A of each color consists of gradual density detecting toner patches A1 through A5 of gradually different grayscales. The gradual density detecting toner patches A1 through A5 are arranged along a line extending in the sub-scanning direction so that the middle sensor 18 can read them on the conveyor belt 5.

The location detecting toner marks B are formed at such locations that all the sensors 17, 18, and 19 can read them on the conveyor belt 5. The location detecting toner marks B are made up of horizontal linear marks that run in parallel with the main-scanning direction, and diagonal linear marks that extend diagonally with respect to the horizontal linear marks. The number of horizontal linear marks in each group of the location detecting toner marks B is four, consisting of a black (BK) line, a cyan (C) line, a magenta (M) line, and a yellow (Y) line. The number of diagonal linear marks in each group of the location detecting toner marks B is also four, consisting of the same color lines as the horizontal linear marks.

The CPU 31 loads the detection signal of the sensor 18 having reading the density detecting toner patches A, from the FIFO memory 27 into the RAM 33 in predetermined timing. From the output of the sensor 18, the CPU 31 detects the densities of the density detecting toner patches A (i.e., the CPU 31 functions as a density detecting means) and sets image forming conditions as to the image densities of images to be formed by the image forming units 6Y, 6M, 6C, and 6BK, in accordance with the detected densities (i.e., the CPU 31 functions as an image forming condition setting means). The setting of the image forming conditions includes the setting of the laser beam power of the exposure unit 11 driven by the write control base member 29, and the setting of the developing bias and the charging bias to be outputted from the bias control unit 28.

The CPU 31 then loads the detection signals of the sensors 17, 18, and 19 having read the location detecting toner marks B, from the FIFO memory 27 into the RAM 33 in predetermined timing. From the outputs of the sensors 17, 18, and 19, the CPU 31 detects the location deviations between the reference color (black in this embodiment) and the other colors. (i.e., the CPU 31 functions as a location deviation detecting means). Based on the detected location deviations, the CPU 31 corrects the locations of images formed on the photosensitive drums 9Y, 9M, 9C, and 9BK by the image forming units 6Y, 6M, 6C, and 6BK (i.e., the CPU 31 functions as an image location correcting means).

As the densities of the density detecting toner patches A can be detected with the sensor 18 that is designed to detect location deviations of images, it is unnecessary to prepare an independent density sensor specially designed for density detection. Thus, the production costs can be lowered.

In this case, since the densities of the density detecting toner patches A can be detected with the sensor 18 closest to the center of the main-scanning direction on the conveyor belt 5, the density detecting toner patches A in an area having the average toner application amount can be read even if the toner supply amounts in the main-scanning direction vary among the developers; 12Y, 12M, 12C, and 12BK. Accordingly, the density of a toner image in the center area having the average toner application amount in the entire image forming area in the main-scanning direction is detected so as to set optimum image forming conditions.

Furthermore, density detecting toner patches A are produced for each color so as to set the image forming conditions for each color. Thus, the density of an image of each color can be set at a desired level.

Moreover, as the sensors 17, 18, and 19 are arranged on one base member 20, the structure can be simplified compared with a structure in which each sensor has a base member.

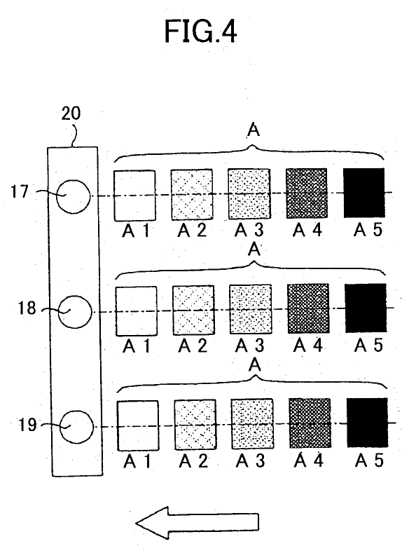

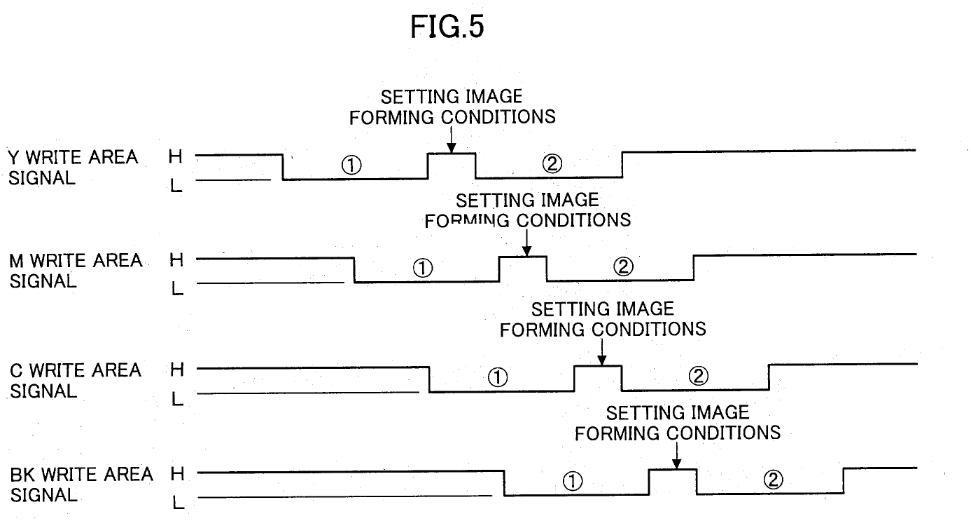

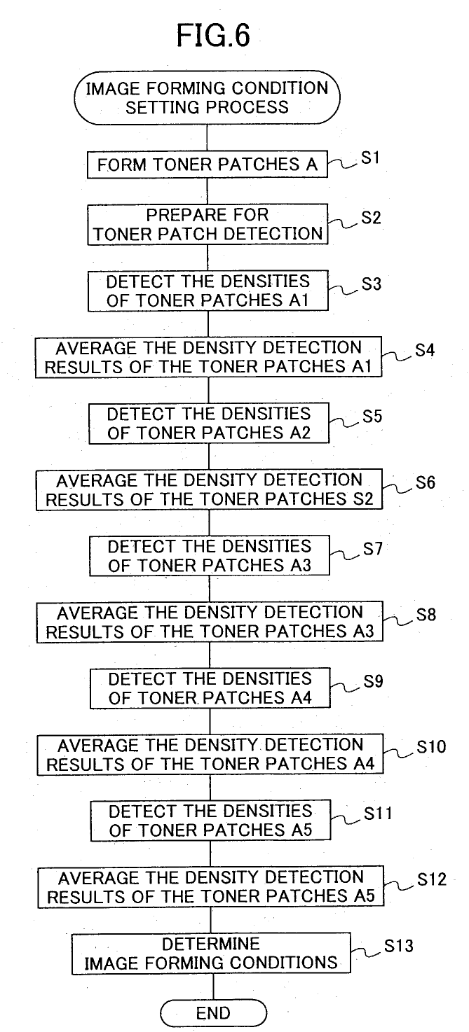

Referring now to FIGS. 4 through 6, a second embodiment of the present invention will be described. In FIGS. 4 through 6, the same components as those of the first embodiment are denoted by the same reference numerals as those in FIGS. 1 through 3, and explanation of them is omitted herein. FIG. 4 illustrates the relationship between the density detecting toner patches A and the sensors, 17, 18, and 19. FIG. 5 is a timing chart of signals for forming the density detecting toner patches A and the location detecting toner marks B. FIG. 6 is a flowchart of the image forming condition setting process.

In this embodiment, the CPU 31 drives the image forming units 6Y, 6M, 6C, and 6BK to form the density detecting toner patches A of each color at such locations that:a plurality of sensors (the sensors 17, 18, and 19 in this embodiment) can read the density detecting toner patches A on the conveyor belt 5. The density detecting toner patches A of each color at the different locations are a group consisting of density detecting toner patches A1 through A5 that have gradual grayscales and are arranged along a straight line. If the density detecting toner patches A1 through A5 of one color have the same grayscales, the densities of the density detecting toner patches A1 through A5 are uniform.

After the density detecting toner patches A are formed at the different locations in the main-scanning direction, the location detecting toner marks B are formed in the same manner as in the first embodiment, at such locations that all the sensors 17, 18, and 19 can read them.

While FIG. 4 shows that the density detecting toner patches A of each one color are formed at different locations in the main-scanning direction, FIG. 5 shows that the density detecting toner patches A are formed with each write region signal for yellow (Y), magenta (M), cyan (C), and black (BK) during a period \mathring{1}. Image forming conditions are then determined from the densities of the density detecting toner patches A of each color, and the location detecting toner marks B are formed during a period \mathring{2}.

Referring now to the flowchart shown in FIG. 6, the image forming condition setting process in this embodiment will be described in detail. After the density detecting toner patches A are formed in the above described manner in step S1, preparations for patch detection, such as setting light quantities of the sensors 17, 18, and 19, are made in step S2. The densities of the toner patches A1 are detected from the detection signals transmitted from the sensors 17, 18, and 19 in step S3. The density detection results with respect to the toner patches A1 are then averaged in step S4. Likewise, the densities of the density detecting toner patches A2 of the next higher grayscale level are detected in S5, and the density detection results with respect to the toner patches A2 are averaged in step S6. The densities of the density detecting toner patches A3 are detected in step S7, and the density detection results with respect to the toner patches A3 are averaged in step S8. The densities of the density detecting toner patches A4 are detected in step S9, and the density detection results with respect to the toner patches A4 are averaged in step S10. The densities of the density detecting toner patches A5 are detected in step S11, and the density detection results with respect to the toner patches A5 are averaged in step S12. From the averaged data, the image forming conditions for the color corresponding to the color of the density detecting toner patches A are determined in step S13, and the operation then returns to the main routine. After the image formation conditions for each one color are determined, the other image forming conditions such as the laser beam power of the exposure unit 11, the developing bias of the developer 12, and the charging bias of the charger 10, are set in accordance with the obtained results. This image forming condition setting process shown in FIG. 6 is carried out for each color.

Although examples of determining image forming conditions by forming the density detecting toner patches A for all the sensors 17, 18, and 19 to detect and then performing an averaging operation have been described above, the methods of forming the density detecting toner patches are not limited to those examples. For instance, the density detecting toner patches A may be formed for the sensors 17 and 19 in the main-scanning direction, and the density detection results are averaged to determine the image forming conditions. In this manner, the same effects as those examples can be obtained. However, the example shown in FIG. 4 is more preferable, because the problem of density variations in the main-scanning direction can be avoided by averaging the density detection results with respect to the density detecting toner patches A formed for all the sensors 17, 18, and 19 arranged at different locations in the main-scanning direction.

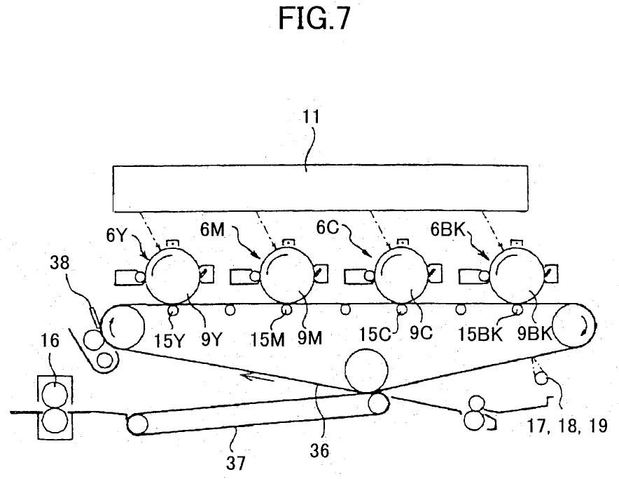

Referring now to FIG. 7, a third embodiment of the present invention will be described. In FIG. 7, the same components as those in the foregoing embodiments are denoted by the same reference numerals as those in FIGS. 1 through 5, and explanation of them is omitted herein. In this embodiment, an intermediate transfer belt 36 as an intermediate transfer unit is employed instead of the conveyor belt 5 shown in FIG. 1. Each image formed by the image forming units 6Y, 6M, 6C, and 6BK is temporarily transferred onto the intermediate transfer belt 36, and the transferred image is further transferred from the intermediate transfer belt 36 onto a paper sheet by a transfer belt 37 that serves as a transfer means. This transfer belt 37 also has a function of conveying paper sheets to the fixing unit 16. In this embodiment, a cleaning device 38 is also employed to wipe excess toner off the intermediate transfer belt 36.

The toner mark forming means of this embodiment forms the location detecting toner marks of each color on the intermediate transfer belt 36. Also, the toner patch forming means of this embodiment forms the density detecting toner patches of each color on the intermediate transfer belt 36. Because of this, the sensors 17, 18, and 19 that are the same as those of the foregoing embodiments are arranged in the main-scanning direction that is perpendicular to the rotating direction of the intermediate transfer belt 36. Referring back to FIGS. 3 and 4, the direction indicated by the bigger arrow in each drawing is equivalent to the rotating direction of the intermediate transfer belt 36, and the direction that is perpendicular to this direction indicated by the bigger arrows is the main-scanning direction along which the sensors 17, 18, and 19 are arranged. The location detecting toner marks B are formed at such locations that all the sensors 17, 18, and 19 can detect them. The density detecting toner patches A are formed at such locations that the middle sensor 18 can detect them, as shown in FIG. 3, or are formed at such locations that all the sensors 17, 18, and 19 can detect them, as shown in FIG. 4.

As described above, the locations of the location detecting toner marks B on the intermediate transfer belt 36 are detected, so that the locations of images formed on the photosensitive drums 9Y, 9M, 9C, and 9BK can be corrected in this embodiment. Further, the densities of the density detecting toner patches A on the intermediate transfer belt 36 are detected, so that the image forming conditions as to the image densities of images to be formed by the image forming units 6Y, 6M, 6C, and 6BK can be properly set. Also, in this embodiment, the density detecting toner patches A can be detected by at least one of the sensors 17, 18, and 19 that are designed to detect the location detecting toner marks B, in the same manner as of the foregoing embodiments.

It should be noted that the present invention is not limited to the embodiments specifically disclosed above, but other variations and modifications may be made without departing from the scope of the present invention.

What is claimed is:

1. A color image forming method, comprising the steps of:
forming location detecting toner marks of different colors, using a plurality of electrophotographic image forming units, at three or more locations on a conveyor belt in a main-scanning direction that is perpendicular to the conveying direction of the conveyor belt;
forming density detecting toner patches of different colors, using the image forming units, at different locations on the conveyor belt that are the same as at least one of the location detecting toner marks in the main-scanning direction but different in the sub-scanning direction;
optically reading the location detecting toner marks with three or more sensors arranged in the main-scanning direction;
detecting location deviations of colors with respect to a reference color at each location of the sensors, based on the results of the detection of the location detecting toner marks obtained from the outputs of the sensors;
correcting the locations of images formed on photosensitive members by the image forming units, in accordance with the detected location deviations;
reading the density detecting toner patches with one or more of the sensors that are designed to read the location detecting toner marks; and
setting image forming conditions as to the image densities of images to be formed by the image forming units, based on the densities of the density detecting toner patches detected from the outputs of the sensors.

2. A color image forming apparatus comprising:
a plurality of means for forming image, said means for forming image being arranged in the conveying direction of a conveyor belt and forming images of different colors by electrophotography;
three or more means for sensing, said means for sensing being arranged in a main-scanning direction that is perpendicular to the conveying direction of the conveyor belt;
means forming a toner mark, driving the means forming image to form location detecting toner marks of each color at such locations on the conveyor belt that all the means for sensing can read the respective location detecting toner marks from the conveyor belt;
means for forming a toner patch, driving the means for forming image to form density detecting toner patches of each color at such locations on the conveyor belt that at least one of the means for sensing can read the density detecting toner patches from the conveyor belt;
means for detecting a location deviation, detecting location deviations of colors with respect to a reference color at the location of each means for sensing, based on the outputs of the means for sensing that have read the location detecting toner marks;
means for correcting an image location, correcting the locations of images formed on photosensitive members by the means for forming image, based on the detected location deviations;
means for detecting a density, using one or more of the means for sensing, which read the location detecting toner marks, to detect the densities of the density detecting toner marks based on the output of the one or more sensors that have read the density detecting toner patches; and
means for setting an image forming condition, setting image forming conditions as to the image densities of images to be formed by the means forming image, based on the detected densities.

3. A color image forming apparatus comprising:
plurality of menas for forming image, forming form images of different colors by electrophotography;
an intermediate transfer means onto which images formed by the plurality of means for forming image are transferred, the intermediate transfer means being rotationally driven;
means for transfering the images from the intermediate transfer means to a paper sheet;
three or more means for sensing and being arranged in a main-scanning direction perpendicular to the rotating direction of the intermediate transfer means;
means for forming a toner mark, driving the means forming image to form location detecting toner marks of each color at such location on the intermediate transfer means that all the means for sensing can read the respective location detecting toner marks;
means for forming a toner patch, driving the means for forming image to form density detecting toner patches of each color at such locations on the intermediate transfer means that at least one of the means for sensing can read the density detecting toner patches;
means for detecting a location deviation, detecting location deviations of colors with respect to a reference color at the location of each menas for sensing, based on the outputs of the means for sensing that have read the location detecting toner marks;
means for correcting an image location, correcting the locations of images formed on photosensitive members by the means for forming image, in accordance with the detected location deviations;
means for detecting a density, using at least one of the means for sensing, which read the location detecting toner marks, to detect the densities of the density detecting toner patches, based on the output of at least one of the means for sensing that have read the density detecting toner patches; and
means for setting an image forming condition, setting image forming conditions as to the image densities of images to be formed by the means for forming image, in accordance with the detected densities.

4. The color image forming apparatus as claimed in claim 2, wherein the means for forming toner patch forms the density detecting toner patches at such locations on the conveyor belt that the means for sensing closest to the center of the main-scanning direction can read the density detecting toner patches.

5. The color image forming apparatus as claimed in claim 3, wherein the means for forming toner patch forms the density detecting toner patches at such locations on the intermediate transfer means that the means for sensing closest to the center of the main-scanning direction can read the density detecting toner patches.

6. The color image forming apparatus as claimed in claim 2, wherein:
the means for forming toner patch drives the means for forming image to form density detecting toner patches of the same densities for each color at such locations on the conveyor belt that each corresponding one of the means for sensing can read the density detecting toner patches; and
the means for setting image forming condition sets image forming conditions as to the image qualities of images to be formed by the means for forming image, based on the average value of the outputs of the means for sensing corresponding to the detected densities of the density detecting toner patches.

7. The color image forming apparatus as claimed in claim 3, wherein:
the means for forming toner patch drives the means for forming image to form density detecting toner patches of the same densities for each color at such locations on the intermediate transfer means that each corresponding one of the means for sensing can read the density detecting toner patches; and
the means for setting image forming condition sets image forming conditions as to the image qualities of images to be formed by the means for forming image, based on the average value of the outputs of the means for sensing corresponding to the detected densities of the density detecting toner patches.

8. The image forming apparatus as claimed in claim 2, wherein:
the means for forming toner patch forms density detecting toner patches of each color; and
the means for setting image forming condition sets image forming conditions for each color.

9. The color image forming apparatus as claimed in claim 4, wherein:
the means for forming toner patch forms density detecting toner patches of different grayscale levels; and
the means for setting image forming condition sets image forming conditions as to the image qualities of images to be formed by the means for forming image, based on the average value of the detected densities of the density detecting toner patches of the same grayscale levels.

10. The color image forming apparatus as claimed in claim 2, wherein all the means for sensing are arranged on one base member.

11. A color image forming apparatus comprising:
a plurality of image forming units that are arranged in the conveying direction of a conveyor belt and form images of different colors by electrophotography;
three or more sensors that are arranged in a main-scanning direction that is perpendicular to the conveying direction of the conveyor belt;
a toner mark forming unit that drives the image forming units to form location detecting toner marks of each color at such locations on the conveyor belt that all the sensors can read the respective location detecting toner marks from the conveyor belt;
a toner patch forming unit that drives the image forming units to form density detecting toner patches of each color at such locations on the conveyor belt that at least one of the sensors can read the density detecting toner patches from the conveyor belt;
a location deviation detecting unit that detects location deviations of colors with respect to a reference color at the location of each sensor, based on the outputs of the sensors that have read the location detecting toner marks;
an image location correcting unit that corrects the locations of images formed on photosensitive members by the image forming units, based on the detected location deviations;
a density detecting unit that uses one or more of the sensors, which read the location detecting toner marks, to detect the densities of the density detecting toner marks based on the output of the one or more sensors that have read the density detecting toner patches; and
an image forming condition setting unit that sets image forming conditions as to the image densities of images to be formed by the image forming units, based on the detected densities.

12. A color image forming apparatus comprising:
a plurality of image forming units that form images of different colors by electrophotography;
an intermediate transfer unit onto which images formed by the plurality of image forming units are transferred, the intermediate transfer unit being rotationally driven;
a transfer unit that transfers the images from the intermediate transfer unit to a paper sheet;
three or more sensors that are arranged in a main-scanning direction perpendicular to the rotating direction of the intermediate transfer unit;
a toner mark forming unit that drives the image forming units to form location detecting toner marks of each color at such location on the intermediate transfer unit that all the sensors can read the respective location detecting toner marks;
a toner patch forming unit that drives the image forming units to form density detecting toner patches of each color at such locations on the intermediate transfer unit that at least one of the sensors can read the density detecting toner patches;
a location deviation detecting unit that detects location deviations of colors with respect to a reference color at the location of each sensor, based on the outputs of the sensors that have read the location detecting toner marks;
an image location correcting unit that corrects the locations of images formed on photosensitive members by the image forming units, in accordance with the detected location deviations;
a density detecting unit that uses at least one of the sensors, which read the location detecting toner marks, to detect the densities of the density detecting toner patches, based on the output of at least one of the sensors that have read the density detecting toner patches; and
an image forming condition setting unit that sets image forming conditions as to the image densities of images to be formed by the image forming units, in accordance with the detected densities.

13. The color image forming apparatus as claimed in claim 11, wherein the toner patch forming unit forms the density detecting toner patches at such locations on the conveyor belt that the sensor closest to the center of the main-scanning direction can read the density detecting toner patches.

14. The color image forming apparatus as claimed in claim 12, wherein the toner patch forming unit forms the density detecting toner patches at such locations on the intermediate transfer unit that the sensor closest to the center of the main-scanning direction can read the density detecting toner patches.

15. The color image forming apparatus as claimed in claim 11, wherein:
the toner patch forming unit drives the image forming units to form density detecting toner patches of the same densities for each color at such locations on the conveyor belt that each corresponding one of the sensors can read the density detecting toner patches; and
the image forming condition setting means sets image forming conditions as to the image qualities of images to be formed by the image forming units, based on the average value of the outputs of the sensors corresponding to the detected densities of the density detecting toner patches.

16. The color image forming apparatus as claimed in claim 12, wherein:
the toner patch forming unit drives the image forming units to form density detecting toner patches of the same densities for each color at such locations on the intermediate transfer unit that each corresponding one of the sensors can read the density detecting toner patches; and
the image forming condition setting unit sets image forming conditions as to the image qualities of images to be formed by the image forming units, based on the average value of the outputs of the sensors corresponding to the detected densities of the density detecting toner patches.

17. The image forming apparatus as claimed in claim 11, wherein:
the toner patch forming unit forms density detecting toner patches of each color; and
the image forming condition setting unit sets image forming conditions for each color.

18. The color image forming apparatus as claimed in claim 13, wherein:
the toner patch forming unit forms density detecting toner patches of different grayscale levels; and
the image forming condition setting unit sets image forming conditions as to the image qualities of images to be formed by the image forming units, based on the average value of the detected densities of the density detecting toner patches of the same grayscale levels.

19. The color image forming apparatus as claimed in claim 11, wherein all the sensors are arranged on one base member.
